(19) United States
(12) Patent Application Publication
(10) Pub. No.: US 2021/0229223 A1
(43) Pub. Date: Jul. 29, 2021

(54) Method of Sensing and Initializing A Zero Height for A Computer-Controlled Cutting Machine

(71) Applicant: Benjamin Cramer, Varysburg, NY (US)

(72) Inventor: Benjamin Cramer, Varysburg, NY (US)

(21) Appl. No.: 17/161,653

(22) Filed: Jan. 28, 2021

Related U.S. Application Data
(60) Provisional application No. 62/966,879, filed on Jan. 28, 2020.

(51) Int. Cl. B23K 37/02

(52) U.S. Cl. CPC B23K 37/0229; B23K 37/0247

(57) ABSTRACT

A method of sensing and initializing a zero-height for a computer-controlled cutting machine implements ohmic contact between a tool head of the cutting machine and a work surface of the cutting machine in order to ascertain a zero-height of the tool head before executing a machine control operation, ensuring the tool head is positioned correctly at a predetermined operating height above the work surface throughout the machine control operation. A baseline electrical resistance is tracked across the work surface. A downward movement of the tool head toward the work surface is executed with a gantry-style movement mechanism of the cutting machine. The downward movement is stopped and a current height of the tool head is designated as the zero-height if a change in the baseline electrical resistance is detected. The tool head is electrically isolated in order to facilitate detection of the change in resistance.

The current application claims a priority to the U.S. Provisional Patent application Ser. No. 62/966,879 filed on Jan. 28, 2020.

### FIELD OF THE INVENTION

The present invention relates generally to computer-controlled cutting machines. More particularly, the present invention relates to sensing a zero-height reference for computer-controller cutting machines.

### BACKGROUND OF THE INVENTION

Computing-controlled cutting machines such as oxy-fuel torch cutting machines and scribing machines rely on predetermined movement commands generated by a machine control program and read and executed by the cutting machine. Such commands are typically static movement commands, telling the machine to move in a particular direction at a particular speed for a particular length of travel. These “blind” machine commands require initialization of a starting point of some sort to “know” the position of the tool head at any given time.

Currently, cutting machines such as oxy-fuel and scribing machines typically do not have active position sensing, and rely on initialization along the various axes of movement, whether through manual positioning by an operator or by sensing a zero position in some manner.

For such cutting machines, the height of the tool head above the workpiece is important to control, but typically there is no specific set value, and instead has a range of operation that must simply be known and accounted for by the operator.

Is is therefore the objective of the present invention to provide an automated method for sensing and initializing a zero height value for computer-controlled cutting machines in order to enable more precise control of the height of the tool head during a cutting operation.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is an illustration showing a front perspective view of the computer-controlled cutting machine.

FIG. 2 is an illustration showing a front perspective view of the computer-controlled cutting machine with the tool head lowered to make contact with the work surface in order to initialize the zero-height.

FIG. 3 is a general schematic diagram of the present invention.

FIG. 4 is a stepwise flow diagram describing the general method of the present invention.

FIG. 5 is a stepwise flow diagram describing various attributes of the computer-controlled cutting machine of the present invention.

FIG. 6 is a stepwise flow diagram describing steps for executing a machine control operation after the zero-height is initialized.

FIG. 7 is a stepwise flow diagram describing steps for detecting a change in the baseline electrical resistance across the work surface.

FIG. 8 is a stepwise flow diagram describing various attributes of the computer-controlled cutting machine of the present invention in various embodiments.

FIG. 9 is a stepwise flow diagram describing further steps for steps for detecting the change in the baseline electrical resistance across the work surface.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is a method for sensing and initializing a zero-height reference for a computer-controlled cutting machine 1. Such cutting machines may include, but are not limited to, oxy-fuel torch cutting machines, scribing machines, or any other relevant type of machine.

The present invention provides an initial height reference when using a scribe or an oxy fuel torch on a gantry style cutting machine. For oxy fuel cutting, this automates one of the critical steps in achieving a good cut by setting a proper torch to material distance. Currently this is achieved on larger tables only and is done with capacitive height sense. For scribe marking, the present invention gives control of mark depth and the ability to turn on the scribe in a precise sequence to minimize the initial dimple that is created in a mark operation. An operator can repeatedly produce the exact same mark and have precise control of the mark imprint.

The present invention accomplishes its objective by using the tool head 6 of the cutting machine as a resistive, or ohmic, contact. Ohmic contact as referred to herein should be understood to be physical contact between two objects or components that are electrically conductive and produce a change in resistance of a circuit when in contact with each other. No particular extra or specialized components are necessary to implement the ohmic contact, as the tool head 6 itself is electrically conductive.

Currently, many such computer-controlled cutting machine s do not have active position sensing features for monitoring the position of the tool head 6. As such, a zero-height 7 reference point must be initialized in the control software before any cutting operation is started, since for the cutting operation to be successful, it must be performed by the tool head 6 at a specified height above the work surface 4. Without initializing the zero-height 7 reference point, the control software is unable to accurately calculate the current height of the tool head 6 at any given time. Once the zero-height 7 reference is initialized through the present invention, the specified height may be achieved and maintained, or moved intentionally away from where applicable, by the gantry style movement mechanism 3 throughout the cutting operation. It is further noted herein that the height of the tool head 6 above the work surface 4 may be referred to as a Z height, wherein the work surface 4 extends in the horizontal X and Y directions, as such machines are typically configured.

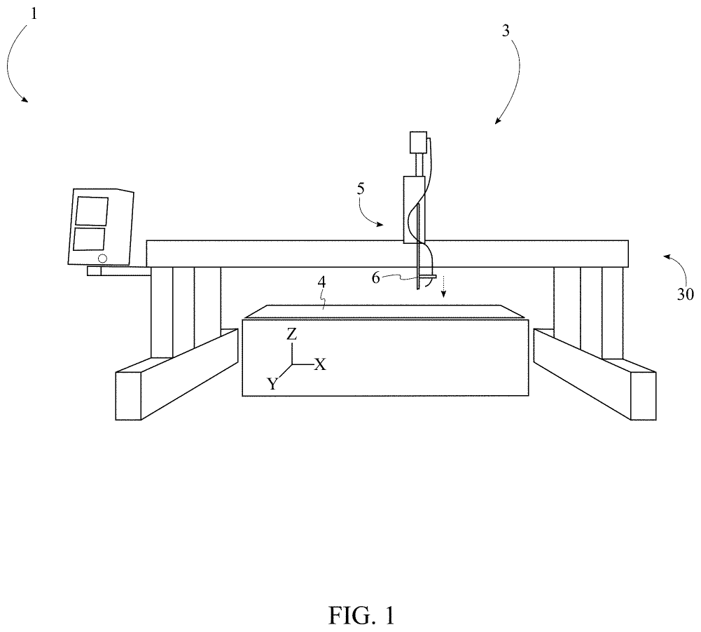

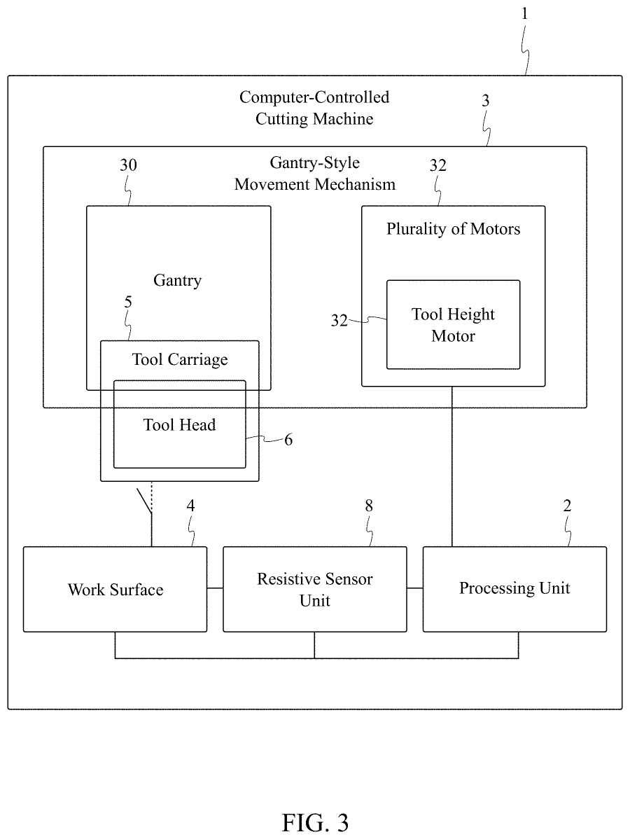

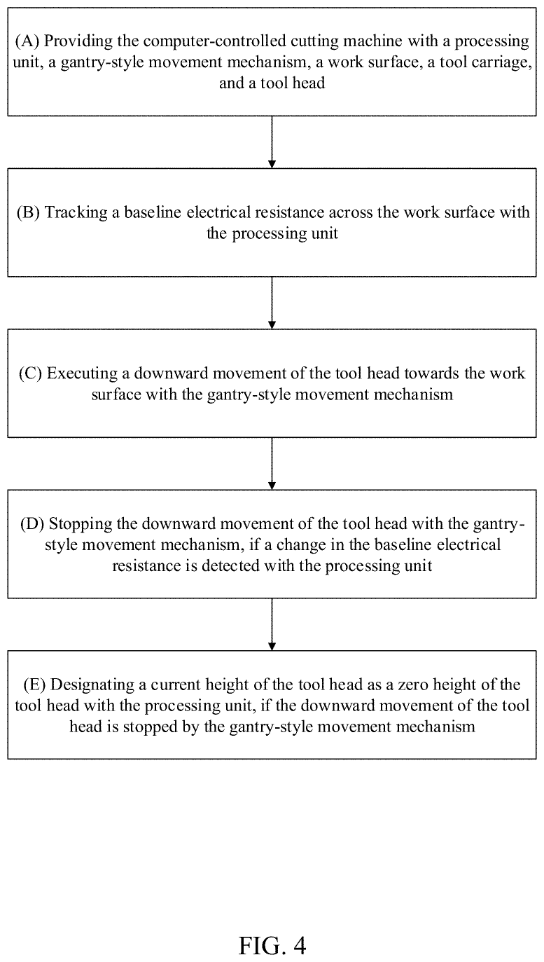

The general method of the present invention is shown in FIG. 4. Referring further to FIGS. 1-3, the computer-controlled cutting machine 1 is provided with a processing unit 2, a gantry style movement mechanism 3, a work surface 4, a tool carriage 5, and a tool head 6 (Step A), wherein the tool carriage 5 is operatively coupled to the gantry style movement mechanism 3, and wherein the tool head 6 is removably mounted to the tool carriage 5. Furthermore, the tool head 6 is electrically isolated from the tool carriage 5, and the tool head 6 and the work surface 4 are electrically conductive.

A baseline electrical resistance is tracked across the work surface 4 with the processing unit 2 (Step B). The particular means of implementation of this step may vary as desired in different embodiments. The work surface 4, being electrically conductive, is electrically connected to the processing unit 2, which continually monitors the resistance of a circuit including the work surface 4.

Continuing with the method, a downward movement of the tool head 6 is executed along the Z direction toward the work surface 4 with the gantry style movement mechanism 3 (Step C). Since initially, the processing unit 2 does not know the vertical position of the tool head 6 above the work surface 4, the work surface 4 must be “found” by the tool head 6, which is the primary spirit and purpose toward which the present invention is directed. Since the tool head 6 should always be positioned generally above the work surface 4, if the tool head 6 is not already in contact with the work surface 4, a downward motion of the tool head 6 will always eventually encounter the work surface 4.

As previously stated, the tool head 6 must be electrically isolated from any other conductive components of the computer-controlled cutting machine 1. Since any given component of the computer-controlled cutting machine 1 is likely going to be electrically conductive, the tool head 6 should be electrically isolated from the rest of the machine;

otherwise, the tool head 6 would, depending on the particular configuration of the machine, likely already be in electrical contact with the remainder of the machine including the work surface 4, rendering the ohmic sensing function of the present invention inoperable.

Therefore, in all embodiments of the present invention, the tool head 6 is electrically isolated from the tool carriage 5. In the preferred embodiment of the present invention, this is accomplished by providing an isolation block with the gantry style movement mechanism 3, wherein the isolation block electrically isolates the tool carriage 5 from the gantry style movement mechanism 3. It is contemplated that various specific means and configurations may be utilized to achieve this objective, and the specific configuration of the isolation block is not of particular importance so long as it adequately electrically isolates the tool head 6 from the tool carriage 5.

If and when the change in the baseline electrical resistance is detected with the processing unit 2 after the downward movement is executed, the downward movement is of the tool head 6 is stopped with the gantry style movement mechanism 3 (Step D). Clearly, once the tool head 6 makes electrical contact with the work surface 4, the objective of the downward movement is accomplished and the downward movement is no longer necessary, and any further downward movement may damage the tool head 6 and/or the work surface 4.

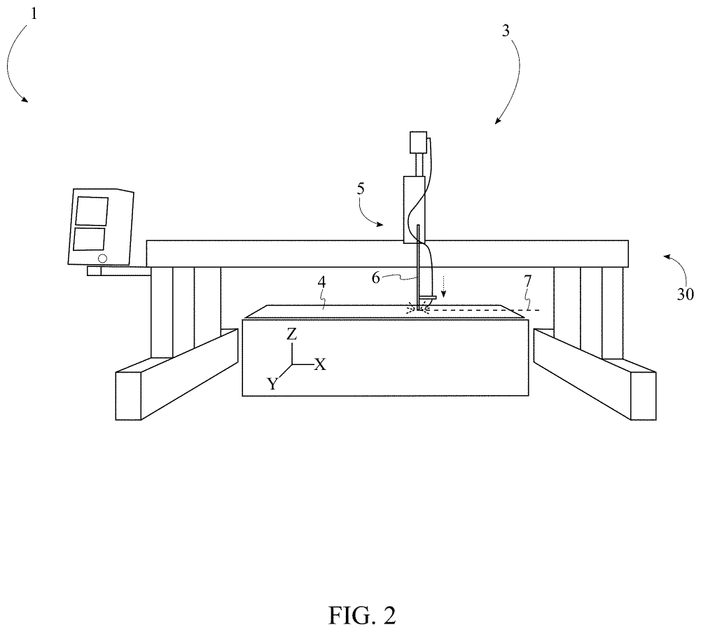

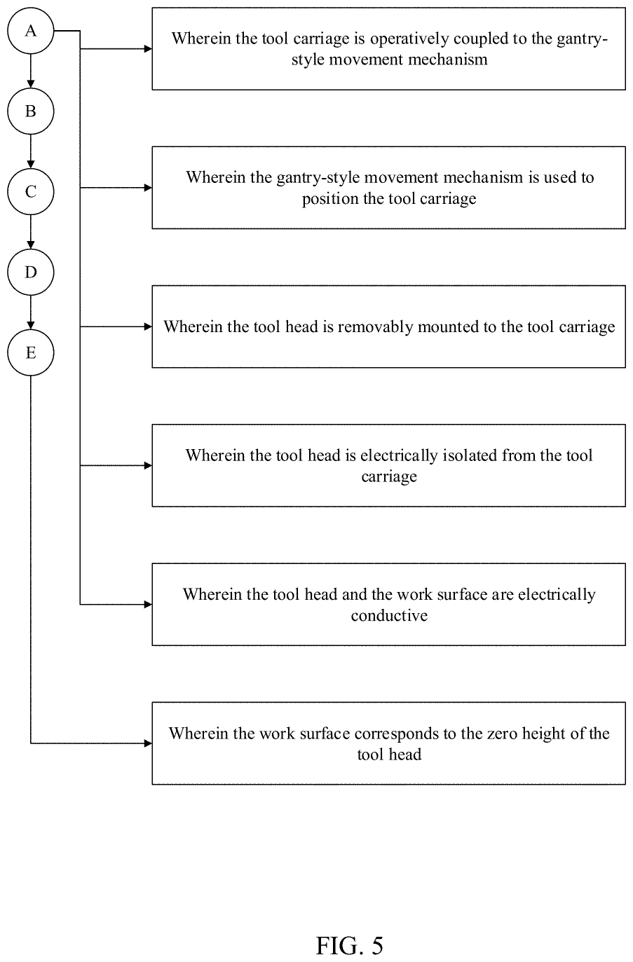

Subsequently, a current height of the tool head 6 is designated as a zero-height 7 of the tool head 6 with the processing unit 2, if the downward movement of the tool head 6 is stopped by the gantry style movement mechanism 3 (Step E), wherein the work surface 4 corresponds to the zero-height 7 of the tool head 6, as shown in FIG. 2 and described in FIG. 5. Thus, the primary objective of the present invention is accomplished; with the zero-height 7 known, the machine may proceed to perform a cutting job with the tool head 6 positioned at an appropriate height above the work surface 4.

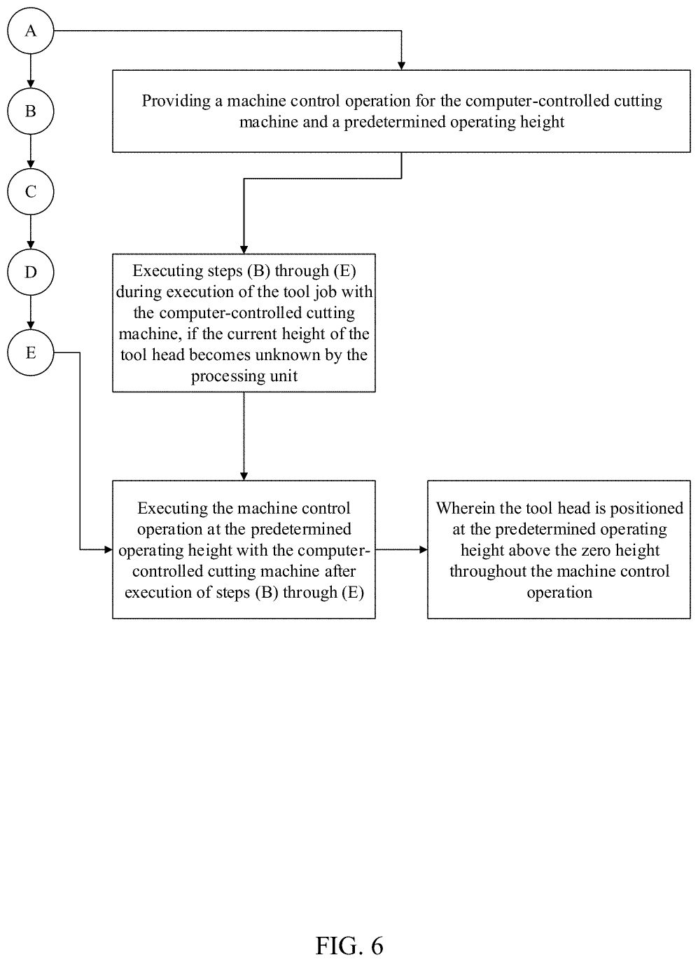

As previously discussed, the primary purpose of the present invention is to sense and initialize a zero-height 7 reference for the tool head 6 in the control software managing the cutting machine in the present invention, and this is done for the purpose of achieving and maintaining an appropriate height above the work surface 4 during a cutting operation. Therefore, in some embodiments, as described in FIG. 6, a machine control operation may be provided for the computer-controlled cutting machine 1, as well as a predetermined operating height. The machine control operation may be understood to be a series of movement and other actuating commands that is read by the processing unit 2 and executed accordingly to move the tool head 6 along a predetermined path or series of paths in order to execute a cutting operation from start to finish.

In some embodiments, the predetermined operating height may be determined by an operator and manually input into the system through a user interface electronically connected to the processing unit 2, or the predetermined operating height may be programmed into the machine control operation, or another method may be utilized to facilitate designation of the predetermined operating height. The predetermined operating height may depend on the specific nature of the tool head 6, or the predetermined operating height may depend on the desired characteristics of a finished workpiece, or the thickness of a workpiece, or other factors. In any case, after Steps B through E have been executing, the machine control operation is subsequently executed at the predetermined operating height with the computer-controlled cutting machine 1, wherein the tool head 6 is positioned at the predetermined operating height above the zero-height 7 throughout the machine control operation.

Furthermore, it may be considered desirable in some instances to re-establish the zero-height 7 if it somehow becomes unknown after being established initially; for instance, after a power outage or earthquake or other disturbance. In such a scenario, steps B through E may be executing during execution of the tool job with the computer-controlled cutting machine 1, if the current height of the tool head 6 becomes unknown by the processing unit 2, or more particularly, if the zero-height 7 becomes unknown by the processing unit 2.

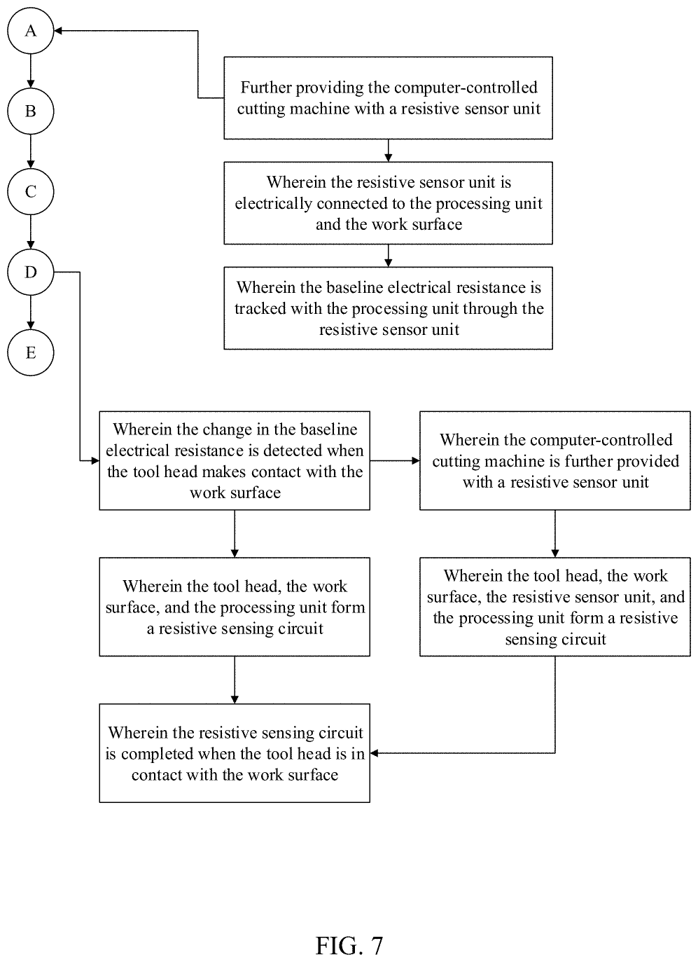

The particular configuration of the physical components necessary to enable the present invention may vary in different embodiments. In some embodiments, wired connections or even simply structural physical contact between components may be sufficient to enable an electrical connection between the processing unit 2 and the work surface 4. In some embodiments, as described in FIG. 7, the computer-controlled cutting machine 1 may be further provided with a resistive sensor unit 8, wherein the resistive sensor unit 8 is electrically connected to the processing unit 2 and the work surface 4, and wherein the baseline electrical resistance is tracked with the processing unit 2 through the resistive sensor unit 8. In some embodiment, the resistive sensor unit 8 may be a standalone unit integrated into the computer-controlled cutting machine 1 and configured particularly for the task of monitoring the baseline electrical resistance across the work surface 4 in conjunction with the processing unit 2. In some embodiments, the resistive sensor unit 8 may simply enabled as a result of pre-existing resistive components and electrical connections of the computer-controlled cutting machine 1.

As previously mentioned, the baseline electrical resistance across the work surface 4 is tracked with the processing unit 2, and in some embodiments in conjunction with an additional resistive sensor unit 8. More particularly, the change in the baseline electrical resistance is detected when the tool head 6 makes contact with the work surface 4, wherein the tool head 6, the work surface 4, the resistive sensor unit 8, and the processing unit 2 form a resistive sensing circuit in such embodiments, and wherein the resistive sensing circuit is completed when the tool head 6 is in electrical contact with the work surface 4.

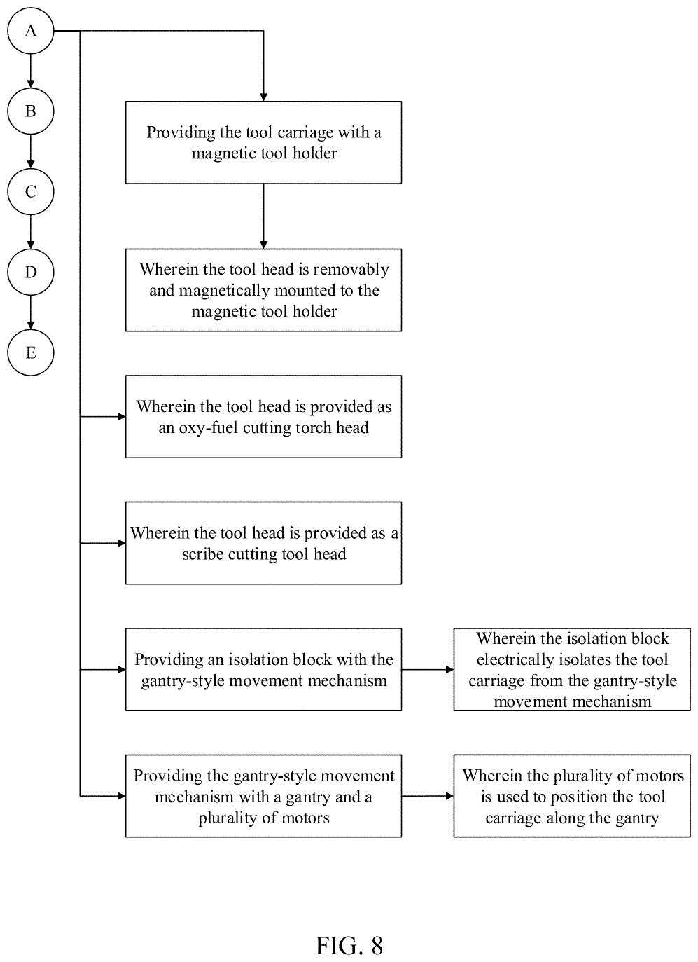

It should be understood that he specific nature of the tool head 6 may vary in different embodiments. Referring to FIG. 8, in some embodiments, the tool head 6 may be provided as an oxy-fuel cutting torch head. In some embodiments, the tool head 6 is provided as a scribe cutting tool head 6. Furthermore, it is preferable in various embodiments of the present invention for the tool head 6 to be easily interchangeable. Thus, in some embodiments, the tool carriage 5 is provided with a magnetic tool holder, wherein the tool head 6 is removably and magnetically mounted to the magnetic tool holder. This arrangement facilitates easily switching from one type of cutting operation to another while preserving the desired zero-height 7 initialization functionality of the present invention.

It is contemplated that the gantry style movement mechanism 3 may vary in different embodiments, and in some embodiments, different types of movement mechanisms may be implemented to position the toolhead without departing from the spirit and scope of the present invention as disclosed here. However, the present invention is primarily directed toward gantry 30-style cutting machines, which generally have one or more vertical structures defining the Z direction, along which one or more horizontal support members moves, with the tool carriage 5 being configured to move along the horizontal support member(s) in the X and Y directions. Moreover, in the preferred embodiment, the gantry style movement mechanism 3 is provided with a gantry 30 and a plurality of motors 32, wherein the plurality of motors 32 is used to position the tool carriage 5 along the gantry 30. The plurality of motors 32 may be understood to include any and all motors involved in the X, Y, or Z movement directions of the tool carriage 5. The plurality of motors 32 may be operatively engaged to various different components of the gantry 30 and tool head 6, depending on the particular motion configuration of the cutting machine.

Moreover and more particularly, in embodiments wherein the computer-controlled cutting machine 1 is further provided with the resistive sensor unit 8, wherein the resistive sensor unit 8 is electrically connected to the processing unit 2 and the work surface 4, the gantry style movement mechanism 3 may be further provided with a tool height motor 34, wherein the tool height motor 34 is used to displace the tool carriage 5 perpendicular to the work surface 4, along the Z direction. Typically, this means the tool height motor 34 displaces the aforementioned horizontal support of the gantry 30, which supports the tool carriage 5, along the Z direction.

A resistance value is continually measured across the work surface 4 with the processing unit 2 through the resistive sensor unit 8, wherein the resistance value is equal to the baseline electrical resistance when the tool head 6 is not in contact with the work surface 4. After the downward movement of the tool head 6 is executed in Step C, the change in the resistance value is detected with the processing unit 2 through the resistive sensor unit 8, wherein the resistance value is changed from the baseline electrical resistance to an increased resistance value when the tool head 6 is in contact with the work surface 4.

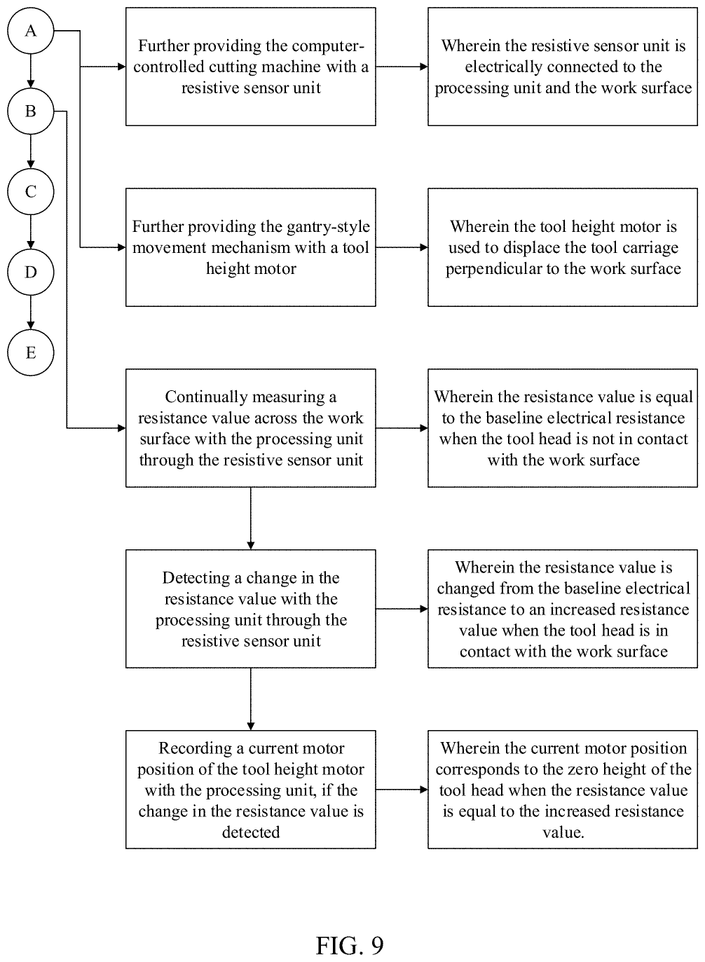

Finally, referring to FIG. 9, a current motor position of the tool height motor 34 may be recorded with the processing unit 2, if the change in the resistance value is detected, wherein the current motor position of the tool height motor 34 corresponds to the zero-height 7 of the tool head 6 when the resistance value is equal to the increased resistance value. In practice, the actual tool height may not be directly known by the processing unit 2, but is rather calculated based on the number of steps or turns the motor has undergone since the zero-height 7 was ascertained. For example, if the tool height motor 34's properties are such that 100 steps of the tool height motor 34 corresponds to a single 360 turn of the tool height motor 34 , and each turn of the tool height motor 34 corresponds to a 1 millimeter change in Z height of the tool head 6, then the processing unit 2 is able to calculate that if, after executing the zero-height 7 initialization process, the motor is actuated by 1000 steps, corresponding to 10 turns of the motor, the new current Z height of the tool head 6 is 10 millimeters above the work surface 4.

Although the invention has been explained in relation to its preferred embodiment, it is to be understood that many other possible modifications and variations can be made without departing from the spirit and scope of the invention as hereinafter claimed.

What is claimed is:

1. A method of sensing and initializing a zero-height for a computer-controlled cutting machine comprising the steps of:
(A) providing the computer-controlled cutting machine with a processing unit, a gantry-style movement mechanism, a work surface, a tool carriage, and a tool head, wherein the tool carriage is operatively coupled to the gantry-style movement mechanism, and wherein the gantry-style movement mechanism is used to position the tool carriage, and wherein the tool head is removably mounted to the tool carriage, and wherein the tool head is electrically isolated from the tool carriage, and wherein the tool head and the work surface are electrically conductive;
(B) tracking a baseline electrical resistance across the work surface with the processing unit;
(C) executing a downward movement of the tool head towards the work surface with the gantry-style movement mechanism;
(D) stopping the downward movement of the tool head with the gantry-style movement mechanism, if a change in the baseline electrical resistance is detected with the processing unit; and
(E) designating a current height of the tool head as a zero-height of the tool head with the processing unit, if the downward movement of the tool head is stopped by the gantry-style movement mechanism.

2. The method of sensing and initializing a zero-height for a computer-controlled cutting machine as claimed in claim 1, wherein the work surface corresponds to the zero-height of the tool head.

3. The method of sensing and initializing a zero-height for a computer-controlled cutting machine as claimed in claim 1 comprising the steps of:
providing a machine control operation for the computer-controlled cutting machine and a predetermined operating height; and
executing the machine control operation at the predetermined operating height with the computer-controlled cutting machine after execution of steps (B) through (E), wherein the tool head is positioned at the predetermined operating height above the zero-height throughout the machine control operation.

4. The method of sensing and initializing a zero-height for a computer-controlled cutting machine as claimed in claim 1 comprising the steps of:
providing a machine control operation for the computer-controlled cutting machine; and
executing steps (B) through (E) during execution of the tool job with the computer-controlled cutting machine, if the current height of the tool head becomes unknown by the processing unit.

5. The method of sensing and initializing a zero-height for a computer-controlled cutting machine as claimed in claim 1 comprising the step of:
further providing the computer-controlled cutting machine with a resistive sensor unit, wherein the resistive sensor unit is electrically connected to the processing unit and the work surface, and wherein the baseline electrical resistance is tracked with the processing unit through the resistive sensor unit.

6. The method of sensing and initializing a zero-height for a computer-controlled cutting machine as claimed in claim 1, wherein the change in the baseline electrical resistance is detected when the tool head makes contact with the work surface, wherein the tool head, the work surface, and the processing unit form a resistive sensing circuit, and wherein the resistive sensing circuit is completed when the tool head is in contact with the work surface.

7. The method of sensing and initializing a zero-height for a computer-controlled cutting machine as claimed in claim 1, wherein the change in the baseline electrical resistance is detected when the tool head makes contact with the work surface, wherein the computer-controlled cutting machine is further provided with a resistive sensor unit, wherein the tool head, the work surface, the resistive sensor unit, and the processing unit form a resistive sensing circuit, and wherein the resistive sensing circuit is completed when the tool head is in contact with the work surface.

8. The method of sensing and initializing a zero-height for a computer-controlled cutting machine as claimed in claim 1 comprising the step of:
providing the tool carriage with a magnetic tool holder, wherein the tool head is removably and magnetically mounted to the magnetic tool holder.

9. The method of sensing and initializing a zero-height for a computer-controlled cutting machine as claimed in claim 1, wherein the tool head is provided as an oxy-fuel cutting torch head.

10. The method of sensing and initializing a zero-height for a computer-controlled cutting machine as claimed in claim 1, wherein the tool head is provided as a scribe cutting tool head.

11. The method of sensing and initializing a zero-height for a computer-controlled cutting machine as claimed in claim 1 comprising the step of:
providing an isolation block with the gantry-style movement mechanism, wherein the isolation block electrically isolates the tool carriage from the gantry-style movement mechanism.

12. The method of sensing and initializing a zero-height for a computer-controlled cutting machine as claimed in claim 1 comprising the step of:
providing the gantry-style movement mechanism with a gantry and a plurality of motors, wherein the plurality of motors is used to position the tool carriage along the gantry.

13. The method of sensing and initializing a zero-height for a computer-controlled cutting machine as claimed in claim 1 comprising the steps of:
further providing the computer-controlled cutting machine with a resistive sensor unit, wherein the resistive sensor unit is electrically connected to the processing unit and the work surface;
further providing the gantry-style movement mechanism with a tool height motor, wherein the tool height motor is used to displace the tool carriage perpendicular to the work surface;
continually measuring a resistance value across the work surface with the processing unit through the resistive sensor unit, wherein the resistance value is equal to the baseline electrical resistance when the tool head is not in contact with the work surface;
detecting a change in the resistance value with the processing unit through the resistive sensor unit, wherein the resistance value is changed from the baseline electrical resistance to an increased resistance value when the tool head is in contact with the work surface; and
recording a current motor position of the tool height motor with the processing unit, if the change in the resistance value is detected, wherein the current motor position corresponds to the zero-height of the tool head when the resistance value is equal to the increased resistance value.
